(19) United States
(12) Patent Application Publication
(10) Pub. No.: US 2004/0154360 A1
(43) Pub. Date: Aug. 12, 2004

(54) Flight deck door deadbolt assembly

(76) Inventors: James R. Hernandez, Pomona, CA (US); Stephen C. Csik, Monrovia, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/773,998

(22) Filed: Feb. 6, 2004

Related U.S. Application Data
(60) Provisional application No. 60/445,545, filed on Feb. 7, 2003.

(51) Int. Cl. E05B 65/06

(52) U.S. Cl. 70/134

(57) ABSTRACT

A lock assembly is provided having a deadbolt assembly with a deadbolt that is movable between an unlocked position, wherein the deadbolt is in a retracted position and a locked position, wherein the deadbolt is in an extended position. The lock assembly further includes a first lock actuator removably connected to the deadbolt for moving the deadbolt between the unlocked and locked positions and a second lock actuator connected to the deadbolt for moving the deadbolt between the unlocked position, the locked position and a lockout position wherein the deadbolt is connected to the second lock actuator but disconnected from the first lock actuator, rendering the first lock actuator inoperable.

### CROSS-REFERENCE TO RELATED APPLICATION(S)

This application claims priority under 35 U.S.C. §119(e) to U.S. Provisional Application Serial No. 60/445,545, filed on Feb. 7, 2003, the disclosure of which is incorporated by reference.

### FIELD OF THE INVENTION

The present invention relates generally to a lock assembly having a deadbolt that is movable between an unlocked position and a locked position and in particular to a lock assembly having a first lock actuating means for moving the deadbolt between the unlocked and locked positions. The lock assembly further includes a second lock actuating means for moving the deadbolt between the unlocked position, the locked position and a lockout position wherein the deadbolt is connected to the second lock actuating means but disconnected from the first lock actuating means, thereby rendering the first lock actuating means inoperable.

### BACKGROUND

Due to recent terrorist attacks on airplanes in the United States, security measures in the airline industry have become a top priority. For instance, past terrorist attacks have included terrorists overtaking flight crew personnel and assuming control of the airplane. Accordingly, a need exist for an improved lock assembly for attachment to an airplane cockpit door assembly that prevents unauthorized persons from entering the cockpit.

### SUMMARY

In one embodiment, the present invention includes a lock assembly having a deadbolt assembly with a deadbolt that is movable between an unlocked position, wherein the deadbolt is in a retracted position and a locked position, wherein the deadbolt is in an extended position. The lock assembly further includes a first lock actuating means removably connected to the deadbolt for moving the deadbolt between the unlocked and locked positions and a second lock actuating means connected to the deadbolt for moving the deadbolt between the unlocked position, the locked position and a lockout position wherein the deadbolt is connected to the second lock actuating means but disconnected from the first lock actuating means, thereby rendering the first lock actuating means inoperable.

In another embodiment, the present invention includes a lock assembly that includes a deadbolt assembly having a cam connected to a deadbolt for moving the deadbolt between an unlocked position, wherein the deadbolt is in a retracted position and a locked position, wherein the deadbolt is in an extended position. The lock assembly also includes a housing assembly having a first rotary lock actuating means removably connected to the deadbolt for moving the deadbolt between the unlocked and locked positions and a second rotary lock actuating means connected to the housing assembly and to the deadbolt for moving -the deadbolt between the unlocked and locked positions. The second lock actuating means has a lockout position wherein the deadbolt is connected to the second lock actuating means but disconnected from the first rotary lock actuating means, rendering the first rotary lock actuating means inoperable.

In yet another embodiment, the present invention includes a method of operating a lock assembly that includes positioning the lock assembly in an unlocked position, wherein a lock assembly deadbolt is in a retracted position, by actuating either a first lock actuating means or a second lock actuating means in an unlocking direction, wherein in the unlocked position the deadbolt is engaged with both the first lock actuating means and the second lock actuating means. The method also includes positioning the lock assembly in a locked position, wherein the deadbolt is in an extended position, by actuating either the first lock actuating means or the second lock actuating means in a locking direction, wherein in the locked position the deadbolt is engaged with both the first lock actuating means and the second lock actuating means. The method further includes positioning the lock assembly in a lockout position by actuating the second lock actuating means, wherein in the lockout position the deadbolt is engaged with the second lock actuating means and is disengaged with the first lock actuating means.

### BRIEF DESCRIPTION OF THE DRAWINGS

These and other features and advantages of the present invention will be better understood by reference to the following detailed description when considered in conjunction with the accompanying drawings wherein:

FIG. 1 is an exploded perspective view of a lock assembly according to the present invention having a cover assembly, a deadbolt assembly and a housing assembly;

FIG. 2 is an assembled view of the lock assembly of FIG. 1;

FIGS. 3A-3D are front, bottom, back and side views, respectively, of the lock assembly of FIG. 1;

FIG. 4 is an exploded perspective view of the cover assembly of FIG. 1;

FIG. 5 is an assembled perspective view of the cover assembly of FIG. 4;

FIG. 6 is an exploded perspective view of the housing assembly of FIG. 1, wherein the housing assembly includes a key cylinder having a plug mounted therein;

FIG. 7 is an assembled perspective view of the housing assembly of FIG. 6;

FIG. 8 is a perspective view of the plug of FIG. 6;

FIGS. 9A-9C are back, side and front views, respectively, of the plug of FIG. 8;

FIG. 10 is a longitudinal cross-sectional view of the lock assembly of FIG. 1;

FIG. 11 is a perspective view of the back side of the cover assembly of FIG. 1;

FIGS. 12A-12C are front views of the lock assembly of FIG. 1 showing visual indicators for indicating that the lock assembly is in, respectively, an unlocked, a locked and a lockout position;

FIG. 13 is an exploded perspective view of an alternative embodiment of a cover assembly for use in a lock assembly according to the present invention; and

FIG. 14 is a perspective view of the back side of a cover for use in the cover assembly of FIG. 13.

### DETAILED DESCRIPTION OF EMBODIMENTS OF THE INVENTION

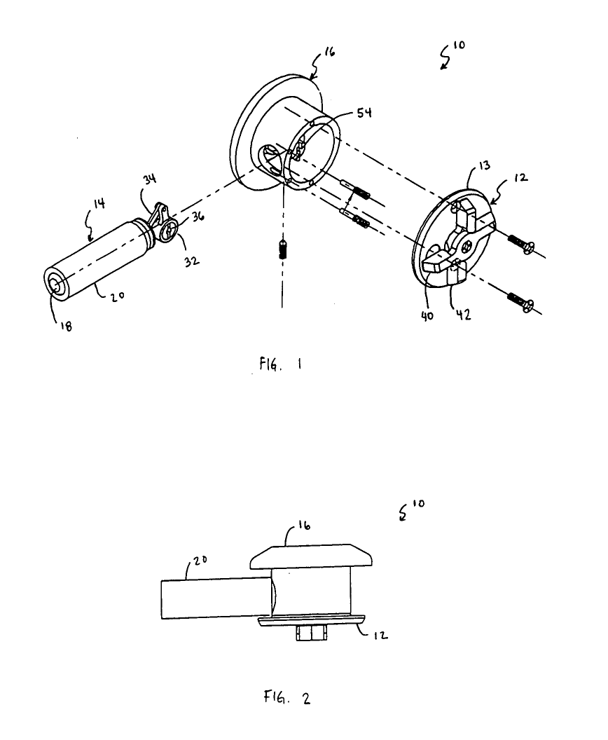

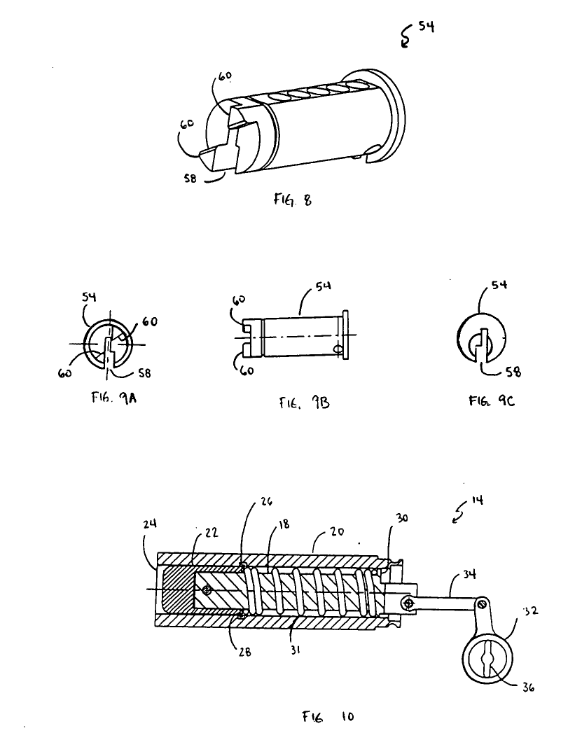

As shown in FIGS. 1-14, embodiments of the present invention are directed to a lock assembly having a deadbolt that is moveable between an unlocked (retracted) position and a locked (extended) position. The lock assembly includes a first lock actuating means on a first side of the deadbolt assembly for moving the deadbolt between the unlocked and locked positions. The lock assembly further includes a second lock actuating means on a second side of the deadbolt assembly for moving the deadbolt between the locked position, the unlocked position and a lockout position. In the lockout position the deadbolt is extended and the first lock actuating means is inoperable.

In one embodiment, when the lock assembly is in either the unlocked or the locked position both the first and second lock actuating means are engaged with a device, such as an arm or a T-key, that moves the deadbolt upon actuation by either the first or the second lock actuating means. In this embodiment, when the lock assembly is in the lockout position, the T-key is engaged only with the second lock actuating means, thus rendering the first lock actuating means inoperable.

For example, in one embodiment, the lock assembly is attached to an airplane cockpit door, such that the first lock actuating means faces a cabin or passenger side of the door and the second lock actuating means faces a flightdeck or cockpit side of the door. This allows flight crew personnel or other persons within the cockpit to place the deadbolt assembly in the lockout position, thus rendering the first lock actuating means inoperable, and preventing any person, such as a potential terrorist, from unlocking the door from the cabin or passenger side of the door. In one embodiment, the lock assembly is attached to the cockpit door of a single aisle airplane such as a 737.

An exemplary lock assembly 10 is shown in FIGS. 1-3D. In the depicted embodiment, the lock assembly 10 includes a cover assembly 12 and a deadbolt assembly 14, each mounted to a housing assembly 16.

The deadbolt assembly 14, as shown in FIG. 10, includes a deadbolt 18 that is moveable along a bolt guide 20. The deadbolt 18 is connected to a bolt head 22 by a fastening means, such as a screw, a pin, a weld, or an adhesive, among other fastening means. Alternatively, the deadbolt 18 and the bolt head 22 can be integrally formed. For simplicity, the deadbolt 18 and the bolt head 22 will hereinafter be jointly refereed to as the deadbolt 18.

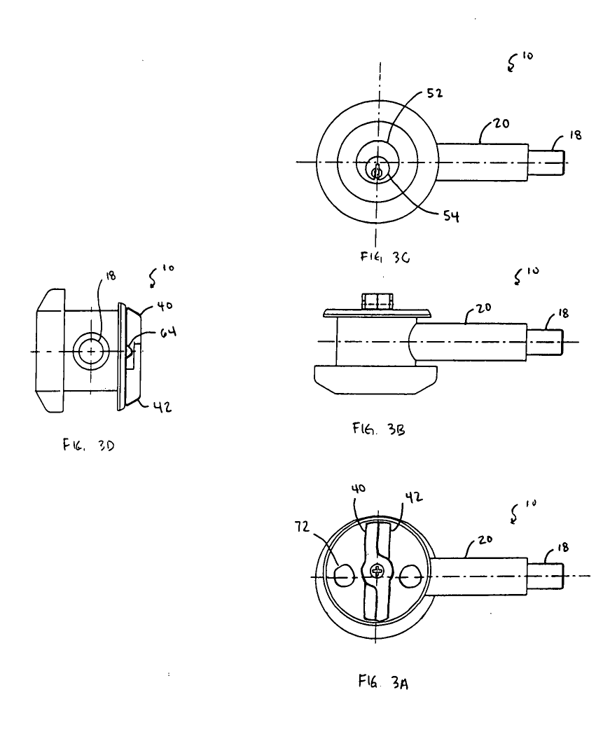

The deadbolt 18 is moveable along the bolt guide 20 between an extended position (a locked position) wherein the deadbolt 18 protrudes from an opening 24 in the bolt guide 20 (as shown in FIGS. 3A-3C) for engagement with a door jam opening, and a retracted position (an unlocked position) wherein the deadbolt 18 is retracted from the dead guide opening 24 (as shown in FIGS. 1, 2 and 10) for disengagement with a door jam opening.

In one embodiment, the deadbolt 18 is biased towards the unlocked position. For example, in one embodiment an inner surface of the bolt guide 20 includes a groove 26 for receiving a snap ring 28 and the deadbolt 18 includes a shoulder 30, such that a compression element 31, for example a spring, is compressed between the snap ring 28 and the deadbolt shoulder 30 when the deadbolt 18 is moved towards the locked position. Alternatively, the groove 26 and snap ring 28 combination is replaced by a similar structure that produces a protrusion from an inner surface of the bolt guide 20 for receiving and compressing the compression element 31.

Biasing the deadbolt 18 towards the unlocked position prevents a potential terrorist from being able to wedge a tool, such as a screw driver, between the deadbolt 18 and the bolt guide 20 to forcibly detach the deadbolt 18 from the lock assembly 10.

FIG. 10 also shows a cam 32 connected to the deadbolt 18. The cam 32 may be attached directly to the deadbolt 18 or indirectly through a link or links 34. When one or both of the first and second lock actuating means are rotary lock actuating means (as described below), the cam 32 may include a slot 36 for receiving a device, such as a T-key, that is engaged with the rotary lock actuating means, such that when the T-key rotates against the slot 36, the cam 32, the link 34 and the bolt guide 20, in combination, transfer the rotary force of the rotary lock actuating means to a translational force to move the deadbolt 18 between the locked and unlocked positions.

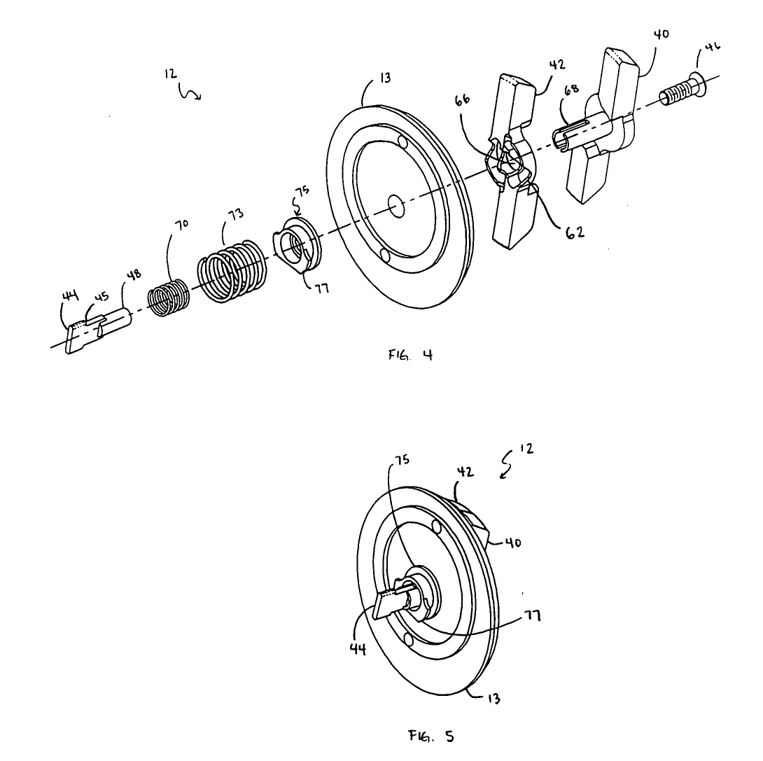

FIGS. 1, 4 and 5 show an exemplary embodiment of the cover assembly 12. FIG. 1 shows a front side of the cover assembly 12 and FIGS. 4 and 5 show a back side of the cover assembly 12. The cover assembly 12 includes a cover 13 that may be attached to the housing assembly 16 by any one of a variety of known methods, such as screw fasteners. In one embodiment, a second lock actuating means is connected to the cover 13.

The second lock actuating means may be any one of a variety of lock actuating means, such as a key cylinder, a rotary knob, a rotary handle, or a linear handle, among other lock actuating means. In the depicted embodiment, the second lock actuating means includes a rotary handle 40. In this embodiment, the handle 40 is connected to a device for translating a movement of the handle 40 to a movement of the deadbolt assembly cam 32. For example, the handle 40 may be connected to an arm, such as a T-key 44. The T-key 44 may be connected to the handle 40 by known means, such as by use of a fastener 46 that engages an internally threaded portion 48 of the T-key 44. For example, a screw fastener may be inserted into an opening in the handle 40 and the cover 13 and threadably engaged with the internally threaded portion 48 of the T-key 44. As such, the handle 40 is rotatably mounted to the cover 13, such that a movement of the handle 40 causes a corresponding movement of the T-key 44.

In one embodiment, when the cover 13 is attached to the housing assembly 16, the T-key 44 is aligned with and engages the slot 36 of the deadbolt assembly cam 32. As a result, movement of the handle 40 causes corresponding movements of the T-key 44 and the cam 32. As described above, movement of the cam 32 causes a corresponding movement of the deadbolt 18. As such, the handle 40 can be used to move the deadbolt 18 between the locked and unlocked positions. In one embodiment, the T-key 44 is made of a heat treated high strength stainless steel to resist torquing.

FIGS. 1, 6 and 7 show an exemplary embodiment of the housing assembly 16. In one embodiment, the housing assembly 16 houses a first lock actuating means. The first lock actuating means may be any one of a variety of lock actuating means, such as a key cylinder, a rotary knob, a rotary handle, or a linear handle, among other lock actuating means. In the depicted embodiment, the first lock actuating means includes a key cylinder 52. The key cylinder 52 includes a plug 54 rotatably mounted therein (see FIG. 3C for a front view of the key cylinder 52 and plug 54). The plug 54 contains a slot 58 for receiving a deadbolt key 56. The plug 54 may be rotated by inserting the deadbolt key 56 into the slot 58 and rotating the key 56. Rotation of the key 56 causes a corresponding rotation of the plug 54.

In an exemplary embodiment, such as that shown in FIG.1, the deadbolt cam 32 is positioned between the plug 54 and the T-key 44, such that the plug 54 is aligned with the deadbolt cam 32 and hence the T-key 44. As previously discussed the T-key 44 engages the slot 36 in the cam 32. In one embodiment, the cam slot 36 transverses the length of the cam 32 such that the T-key 44 is allowed to protrude from a back surface of the cam 32 (i.e. the surface of the cam 32 that faces the plug 54) and engage the plug 54. As shown in FIG. 8, the plug contains protrusions 60, or a similar structure, having a spacing therebetween for receiving the T-key 44. As such, when the T-key 44 is engaged with the plug protrusions 60 in the spacing therebetween and the plug 54 is rotated by rotation of the deadbolt key 56, the rotation of the plug 54 causes the protrusions 60 to push against the T-key 44 causing a rotation of the T-key 44. As described above, rotation of the T-key 44 causes a corresponding rotation of the deadbolt cam 32, which causes a corresponding movement of the deadbolt 18. As such, the key cylinder 52 and key 56 can be used to move the deadbolt 18 between the locked and unlocked positions.

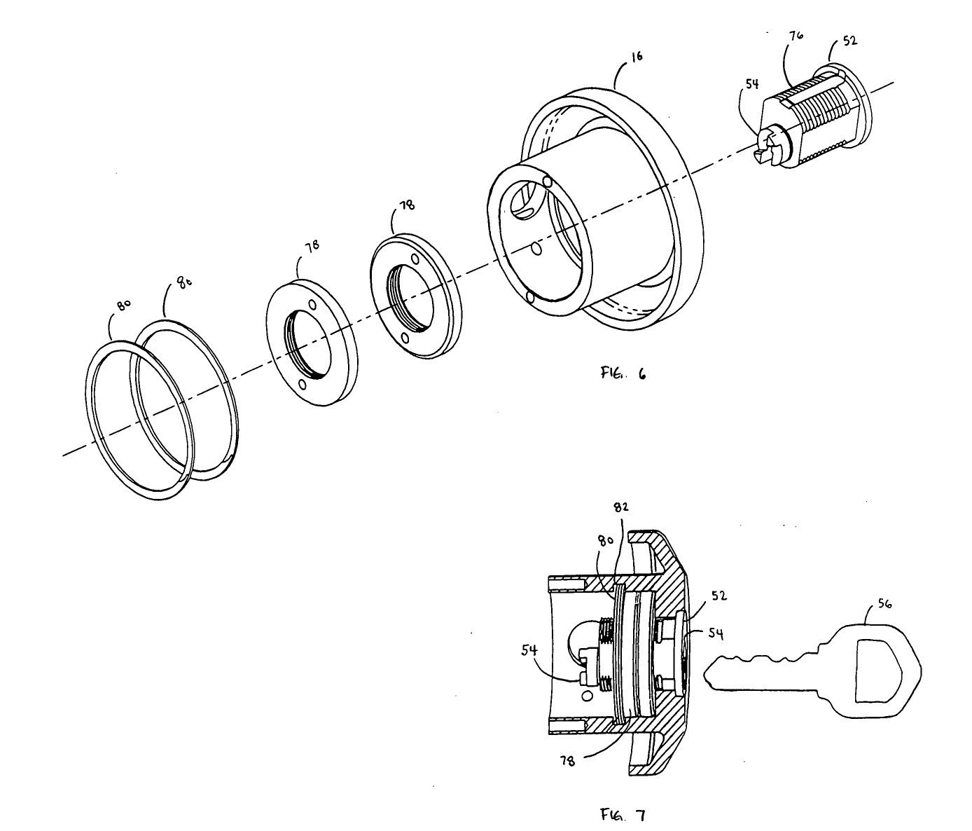

The lock assembly 10 may contain a force transfer means designed to pass a ballistics test, such as a 44 magnum ballistics test. For example, in the embodiment depicted in FIGS. 6 and 7, the lock assembly 10 includes a force transfer pathway wherein threads 76 from the key cylinder 52 threadingly engage one or more internally threaded nuts 78, such as stainless steel nuts, that are disposed adjacent to at least one snap ring 80. The snap ring(s) 80 are disposed within an annular groove 82 in an inner surface of the housing assembly 16. As such, when a bullet is shot at the key cylinder 52, a force from the bullet is transferred along the force transfer pathway from the key cylinder 52, to the nut(s) 78, to the snap ring(s) 80, to the housing assembly 16. This force transfer pathway lessens the probability that the key cylinder 52 can be “shoot out of” or completely disengaged from the lock assembly 10 by firing a bullet at the lock assembly 10, thus increasing the utility of the lock assembly 10 and enabling the lock assembly 10 to pass the ballistics test.

In one embodiment, the second lock actuating means includes a means for disengaging the T-key 44 from the first lock actuating means while maintaining the engagement of the second lock actuating means and the T-key 44, such that the deadbolt 18 may be moved by the second lock actuating means but not by the first lock actuating means. This is referred to as the lockout position of the lock assembly 10.

For example, in the embodiment of FIG. 4, the second lock actuating means includes the handle 40 and an override handle 42. In this embodiment, the handle 40 may be mounted to the cover 13 and the T-key 44 as described above. The override handle 42 includes an opening for receiving an extended portion 68 of the handle 40 for rotatably securing the override handle 42 to the cover assembly 12, such that the override handle 42 is disposed between the handle 40 and the cover 13. In one embodiment, the handle 40 and the override handle 42 include mating cutouts such that both the outer surfaces of the handles 40 and 42 are substantially flush and the and the inner surfaces of the handles 40 and 42 are substantially flush.

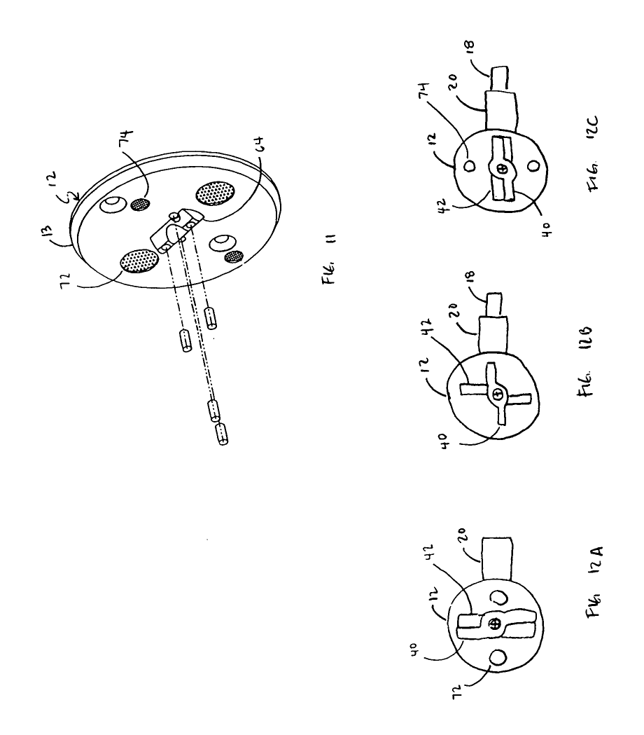

The lockout position may be accomplished by rotating the override handle 42, which results in a sliding communication between a groove 62 in the override handle 42, such as a v-shaped groove, and a mating inclined protrusion 64 (shown in FIG. 11) extending from the cover 13. As the groove 62 of the override handle 42 slides along the inclined protrusion 64 of the cover 13, the override handle 42 “climbs” the inclined protrusion 64 causing the override handle 42 to move in a lateral direction away from the cover 13. This, in turn, causes the handle 40 to correspondingly move in a lateral direction away from the cover 13, which causes the T-key 44 to move in a lateral direction away from and out of engagement with the protrusions 60 of the key cylinder plug 54. The T-key 44 does, however, remain engaged with the cam slot 36. Thus, in the lockout position, rotation of the key cylinder plug 54 does not cause a movement of the deadbolt 18, but rotation of the handle 40 does.

FIG. 13 shows an alternative cover assembly 12′ having an alternative cover 13′ and an alternative override handle 42′. All other components of the cover assembly 12′ are as described above with respect to the cover assembly 12. In the embodiment of FIG. 13, the second lock actuating means includes the handle 40 and an override handle 42′. The handle 40 is mounted to the cover 13′ and the T-key 44 as described above. The override handle 42′ includes an opening for receiving an extended portion 68 of the handle 40 for rotatably securing the override handle 42′ to the cover assembly 12′, such that the override handle 42′ is disposed between the handle 40 and the cover 13′.

In this embodiment, the cover 13′ has two pins 21 extending from its front surface (as shown in FIG. 14.). Each pin 21 has a generally spherical head that extends into a corresponding curved slot 25 in the override handle 42′. Each slot 25 is downwardly ramped such that a first end 25A of each slot 25 has a larger depth than a second end 25B of each slot 25.

In one embodiment, when each pin 21 is engaged with the first end 25A of each slot 25, the override handle 42′ is substantially flush with the cover 13′. The lockout position may be accomplished by rotating the override handle 42′, which results in a sliding communication between each pin 21 and its corresponding slot 25. As each pin 21 slides along its corresponding slot 25 from the first end 25A of the slot 25 to the second end 25B of the slot 25, the downward ramp of each slot 25 causes the pins to apply a “pushing force” to the override handle 42′, causing the override handle 42 to move in a lateral direction away from the cover 13′. This, in turn, causes the handle 40 to correspondingly move in a lateral direction away from the cover 13′, which causes the T-key 44 to move in a lateral direction away from and out of engagement with the protrusions 60 of the key cylinder plug 54 when the cover assembly 13′ is attached to the housing assembly 16 as described above. The T-key 44 does, however, remain engaged with the cam slot 36. Thus, in the lockout position, rotation of the key cylinder plug 54 does not cause a movement of the deadbolt 18, but rotation of the handle 40 does.

As shown in FIGS. 4 and 13, respectively, the cover assembly 12 and 12′ may include a means for biasing the override handle 42 and 42′ towards the cover 13 and 13′. For example, in the depicted embodiments, a compression element 70, such as a spring, is disposed between and compressed by a shoulder 45 of the T-key 44 and an inner surface of the cover 13 and 13′. The cover assembly 12 and 12′ may also include a means for biasing the cover 13 and 13′ towards the cam 32 to ensure an engagement of the T-key 44 with the cam slot 36. For example, in the depicted embodiments, a compression element 73, such as a spring, is disposed between and compressed by a spring flange 75, which is mounted on an inner surface of the cover 13 and 13′, and the cam 32. When the compression element 73 is a spring, the spring flange 75 may include one or more arms 77 for retaining a portion of a first end of the spring and the diameter of the spring is larger than the largest width of the T-key 44 so that the T-key 44 does not impede the engagement of a second end of the spring with the cam 32.

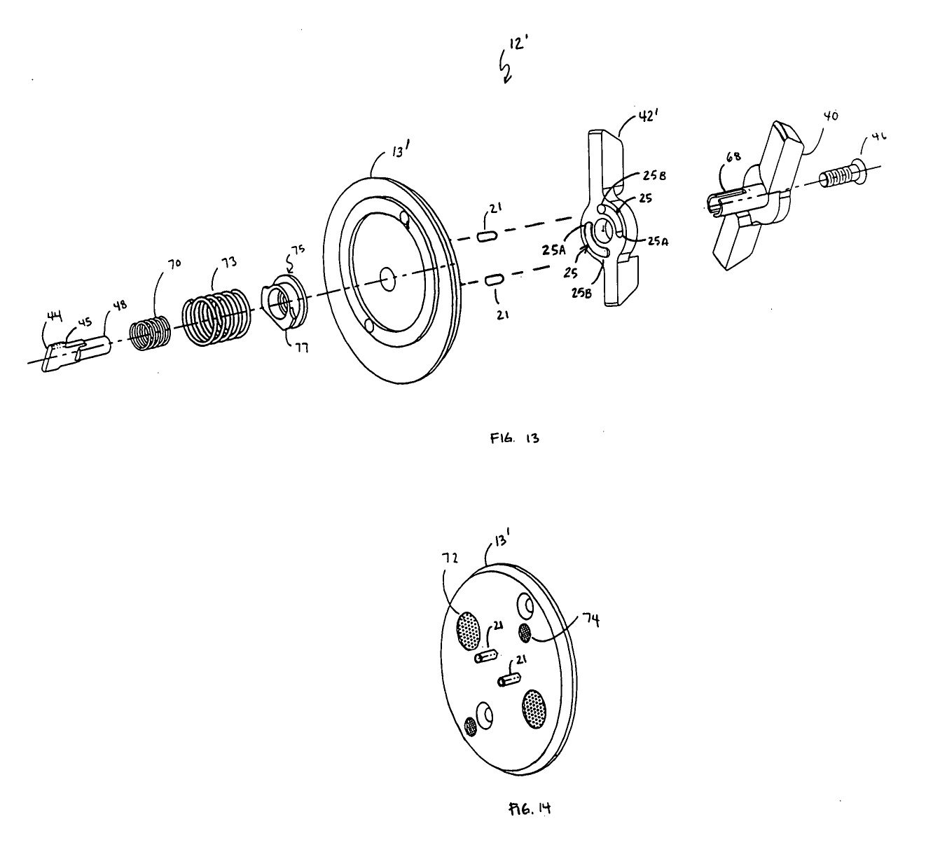

In one embodiment the lock assembly 10 includes visual indicators, such as pictorial indicators, numeric indicators, symbols or color codes, for indicating the position of the deadbolt 18. For example, in the embodiment of FIGS. 12A-12C, the lock assembly 10 includes a first visual indicator 72, such as a red circle, and a second visual indicator 74, such as a green circle. In this embodiment, when the first visual indicator 72 is visible and the second visual indicator 74 is hidden, as in FIG. 12A, the lock assembly 10 is in the unlocked position; when the first and second visual indicators 72 and 74 are both hidden, as in FIG. 12B, the lock assembly 10 is in the locked position; and when the second visual indicator 74 is visible and the first visual indicator 72 is hidden, as in FIG. 12C, the lock assembly 10 is in the lockout position. In the depicted embodiment, the visual indicators 72 and 74 are disposed on an outer surface of the cover 13.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, spirit and scope of this invention. Accordingly, the foregoing description should not be read as pertaining only to the precise structures described and shown in the accompanying drawings, but rather should be read as consistent with and as support for the following claims, which are to have their fullest and fairest scope.

1. A lock assembly comprising:
a deadbolt assembly having a deadbolt that is movable between an unlocked position, wherein the deadbolt is in a retracted position and a locked position, wherein the deadbolt is in an extended position;
a first lock actuating means removably connected to the deadbolt for moving the deadbolt between the unlocked and locked positions; and
a second lock actuating means connected to the deadbolt for moving the deadbolt between the unlocked and locked positions and wherein the second lock actuating means has a lockout position wherein the deadbolt is connected to the second lock actuating means but disconnected from the first lock actuating means, rendering the first lock actuating means inoperable.

2. The lock assembly of claim 1, wherein in the lockout position the deadbolt is in the locked position and can be moved to the unlocked position by the second lock actuating means but cannot be moved to the unlocked position by the first lock actuating means.

3. The lock assembly of claim 1, wherein the second lock actuating means has an arm that is connected to the deadbolt and the first lock actuating means in the unlocked and locked positions, and wherein the arm is connected to the deadbolt but disconnected from the first lock actuating means in the lockout position.

4. The lock assembly of claim 3, wherein the deadbolt assembly includes a cam connected to the deadbolt for moving the deadbolt between the unlocked and locked positions, and wherein the cam includes a slot for receiving the arm.

5. The lock assembly of claim 4, wherein the first lock actuating means includes protrusions for receiving the arm.

6. The lock assembly of claim 1, wherein the first lock actuating means is rotary and the second lock actuating means is rotary.

7. The lock assembly of claim 6, wherein the second lock actuating means includes an arm that engages a slot in a cam that is connected to the deadbolt for moving the deadbolt between the unlocked and locked positions and wherein the first lock actuating means includes protrusions that engage the arm in the unlocked and locked positions but do not engage the arm in the lockout position.

8. The lock assembly of claim 7, wherein rotation of the second lock actuating means causes corresponding rotation of the arm, which causes the cam to move the deadbolt between the unlocked and locked positions.

9. The lock assembly of claim 7, wherein rotation of the first lock actuating means causes the arm to rotate, which causes the cam to move the deadbolt between the unlocked and locked positions.

10. The lock assembly of claim 8, wherein the second lock actuating means is mounted on a cover plate that has a protrusion and wherein the second lock actuating means includes an override handle having a groove that mates with the protrusion, such that a relative movement of the override handle with respect to the protrusion of the cover plate causes the override handle to be laterally displaced from the cover, in turn causing the arm to disconnect from the first lock actuating means.

11. The lock assembly of claim 1, wherein the deadbolt is biased towards the unlocked position.

12. The lock assembly of claim 11, wherein the deadbolt assembly includes a bolt guide having an opening for receiving the deadbolt, and wherein the deadbolt has a shoulder and the bolt guide opening has a shoulder, such that a compression element disposed between the shoulders biases the deadbolt towards the unlocked position.

13. The lock assembly of claim 11, wherein the deadbolt assembly includes a bolt guide having an opening for receiving the deadbolt, the opening also having a groove with a snap ring displaced therein and wherein the deadbolt has a shoulder, such that a compression element disposed between the shoulder and the snap ring biases the deadbolt towards the unlocked position.

14. The lock assembly of claim 1, wherein the first lock actuating means is mounted to a housing assembly and wherein the lock assembly further includes a force transmission means for transmitting an outside force acting on the first lock actuating means to the housing assembly.

15. The lock assembly of claim 14, wherein the first lock actuating means is mounted to the housing assembly through at least one nut and wherein the housing assembly includes an opening having a groove with at least one snap ring displaced therein, wherein the at least one snap ring is adjacent to the at least one nut, such that the outside force acting on the first lock actuating means is transferred from the at least one nut to the at least one snap ring to the housing assembly.

16. A lock assembly comprising:
a deadbolt assembly having a cam connected to a deadbolt for moving the deadbolt between an unlocked position, wherein the deadbolt is in a retracted position and a locked position, wherein the deadbolt is in an extended position;
a housing assembly having a first rotary lock actuating means removably connected to the deadbolt for moving the deadbolt between the unlocked and locked positions; and
a second rotary lock actuating means connected to the housing assembly and to the deadbolt for moving the deadbolt between the unlocked and locked positions and wherein the second lock actuating means has a lockout position wherein the deadbolt is connected to the second lock actuating means but disconnected from the first rotary lock actuating means, rendering the first rotary lock actuating means inoperable.

17. The lock assembly of claim 16, wherein the second rotary lock actuating means includes a rotary handle having an arm that engages a slot in the cam and wherein the first rotary lock actuating means includes protrusions that engage the arm in the unlocked and locked positions but do not engage the arm in the lockout position.

18. The lock assembly of claim 17, wherein rotation of the rotary handle causes a corresponding rotation of the arm, which causes the cam to move the deadbolt between the unlocked and locked positions.

19. The lock assembly of claim 17, wherein rotation of the first rotary lock actuating means causes the arm to rotate, which causes the cam to move the deadbolt between the unlocked and locked positions.

20. The lock assembly of claim 17, wherein the second lock actuating means is mounted on a cover plate that has a protrusion and wherein the second lock actuating means includes an override handle having a groove that mates with the protrusion, such that a relative movement of the override handle with respect to the protrusion of the cover plate causes the override handle to be laterally displaced from the cover, in turn causing the arm to disconnect from the first rotary lock actuating means.

21. The lock assembly of claim 16, wherein the deadbolt is biased towards the unlocked position.

22. The lock assembly of claim 21, wherein the deadbolt assembly includes a bolt guide having an opening for receiving the deadbolt, and wherein the deadbolt has a shoulder and the bolt guide opening has a shoulder, such that a compression element disposed between the shoulders biases the deadbolt towards the unlocked position.

23. The lock assembly of claim 16, further comprising a force transmission means for transmitting an outside force acting on the first rotary lock actuating means to the housing assembly.

24. The lock assembly of claim 23, wherein the first rotary lock actuating means is mounted to the housing assembly through at least one nut and wherein the housing assembly includes an opening having a groove with at least one snap ring displaced therein, wherein the at least one snap ring is adjacent to the at least one nut, such that the outside force acting on the first rotary lock actuating means is transferred from the at least one nut to the at least one snap ring to the housing assembly.

25. A method of operating a lock assembly comprising:
positioning the lock assembly in an unlocked position, wherein a lock assembly deadbolt is in a retracted position, by actuating either a first lock actuating means or a second lock actuating means in an unlocking direction, wherein in the unlocked position the deadbolt is engaged with both the first lock actuating means and the second lock actuating means;
positioning the lock assembly in a locked position, wherein the deadbolt is in an extended position, by actuating either the first lock actuating means or the second lock actuating means in a locking direction, wherein in the locked position the deadbolt is engaged with both the first lock actuating means and the second lock actuating means; and
positioning the lock assembly in a lockout position by actuating the second lock actuating means, wherein in the lockout position the deadbolt is engaged with the second lock actuating means and is disengaged with the first lock actuating means.
